(19) United States
(12) Patent Application Publication
(10) Pub. No.: US 2013/0080725 A1
(43) Pub. Date: Mar. 28, 2013

(54) CONTROL APPARATUS, CONTROL METHOD, AND STORAGE APPARATUS

(71) Applicant: Kazuhiko Usui, Kawasaki (JP)

(72) Inventor: Kazuhiko Usui, Kawasaki (JP)

(73) Assignee: FUJITSU LIMITED, Kawasaki-shi (JP)

(21) Appl. No.: 13/588,451

(22) Filed: Aug. 17, 2012

(30) Foreign Application Priority Data
Sep. 22, 2011 (JP) 2011-206895

(51) Int. Cl. G06F 12/16

(52) U.S. Cl. 711/162; 711/E12.103

(57) ABSTRACT

A control apparatus includes an identifying unit for detecting, upon receiving a request for creating a second bitmap during copying of data from a first storage area to a second storage area, a bit group in which bit values “1” and “0” are present among bit groups of a first bitmap that correspond to respective bits of the second bitmap and identifying a bit having the bit value “1” in the detected bit group, a copy processing unit for copying data managed by the identified bit to the second storage area and changing the bit value of the identified bit from “1” to “0”, and a setting unit for setting the bit value of the bit of the second bitmap that corresponds to the bit group of the first bitmap when the bit value of the identified bit is changed to “0”.

### CROSS-REFERENCE TO RELATED APPLICATION

This application is based upon and claims the benefit of priority of the prior Japanese Patent Application No. 2011-206895, filed on Sep. 22, 2011, the entire contents of which are incorporated herein by reference.

### FIELD

The embodiments discussed herein are related to a control apparatus, a control method, and a storage apparatus.

### BACKGROUND

Techniques for copying data from a storage area of a storage device to another storage area on the basis of a bitmap are known in the art. The storage area of the storage device is divided into sub-areas of a predetermined size, and the bitmap has bits corresponding to the respective sub-areas. The state (ON/OFF) of each bit indicates whether copying of data held in the corresponding sub-area has been completed, for example. When starting a copy process, all the bits of the bitmap are set to “ON”. Then, when copying of data held in a sub-area is completed, the bit corresponding to the sub-area is set to “OFF. When all the bits are set to “OFF”, the copy process is completed.

Also, techniques for dynamically changing the size of a bitmap even during execution of a copy process are known in the art. According to one of these techniques of changing the bitmap size, for example, a plurality of bits of a bitmap before size change correspond to a single bit of a bitmap after size change. Then, if even one or more of the plurality of bits of the bitmap before size change are “ON”, the corresponding bit of the bitmap after size change is set to “ON” (see, for example, Japanese Laid-open Patent Publication No. 2010-146450).

A problem with the above technique of changing the bitmap size is that, when the process of changing the bitmap size is executed, the area of the bitmap that has already been copied is copied again.

### SUMMARY

According to an aspect of the invention, there is provided a control apparatus that includes a processor configured to perform a procedure including: detecting, upon receiving a request for creating a second bitmap having a smaller number of bits than a first bitmap, which has a plurality of bits indicating progress of data copying, by increasing a data size managed by each of the bits of the first bitmap during copying of data from a first storage area to a second storage area, a bit group in which a first value indicating non-completion of data copying and a second value indicating completion of data copying are present among bit groups of the first bitmap that correspond to respective bits of the second bitmap, and identifying a bit having the first value in the detected bit group; copying data managed by the identified bit to the second storage area, and changing the first value of the identified bit to the second value; and creating the second bitmap, and setting to the second value a bit of the second bitmap that corresponds to the bit group containing the identified bit whose value has been changed from the first value to the second value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a storage apparatus according to a first embodiment;

FIG. 2 illustrates an exemplary configuration of a storage system according to a second embodiment;

FIG. 3 illustrates an exemplary hardware configuration of a controller module;

FIG. 4 illustrates an exemplary hardware configuration of a management apparatus;

FIG. 5 is a functional block diagram of the controller module;

FIG. 6 illustrates an example of a session management table;

FIG. 7 illustrates examples of volume management tables;

FIG. 8 illustrates a first changing method;

FIG. 9 illustrates a second changing method;

FIG. 10 is a flowchart of a process performed by the controller module;

FIG. 11 is a flowchart of a copy process for the case where a bit-mixed group is present; and

FIG. 12 is a flowchart of a simulation process.

### DESCRIPTION OF EMBODIMENTS

Embodiments will be described below with reference to the accompanying drawings, wherein like reference numerals refer to like elements throughout.

### (A) First Embodiment

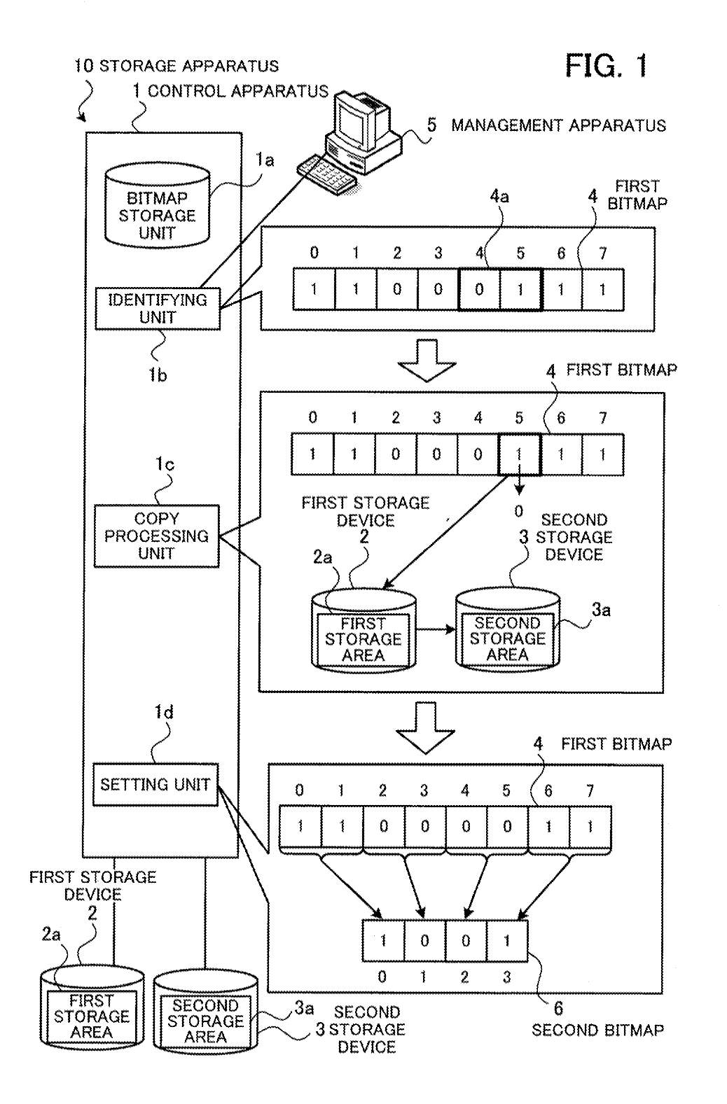

FIG. 1 illustrates a storage apparatus 10 according to a first embodiment.

The storage apparatus 10 according to the first embodiment includes a control apparatus (computer) 1, a first storage device 2, and a second storage device 3. The first storage device 2 and the second storage device 3 are connected to the control apparatus 1. The first storage device 2 and the second storage device 3 may be implemented as solid state drives (SSD), hard disk drives (HDD), or the like.

The control apparatus 1 controls copying of data from a first storage area 2a of the first storage device 2 to a second storage area 3a of the second storage device 3.

The control apparatus 1 includes a bitmap storage unit 1a, an identifying unit 1b, a copy processing unit 1c, and a setting unit 1d. It should be noted that the bitmap storage unit 1a may be implemented as part of a data storage area of a Random Access Memory (RAM) included in the control apparatus 1. The identifying unit 1b, the copy processing unit 1c, and the setting unit 1d may be implemented as functions of a central processing unit (CPU) of the control apparatus 1.

The bitmap storage unit 1a stores a first bitmap 4 which has a plurality of bits each indicating the progress of copying of data from the first storage area 2a to the second storage area 3a. The first bitmap 4 illustrated in FIG. 1 has eight bits numbered 0 through 7 (bit 0 through bit 7). The first storage area 2a is divided into blocks of a predetermined size, and the bits of the first bitmap 4 correspond to the respective blocks. Each bit has a value (“1” or “0”) indicating the progress of copying of the corresponding block. The value “1” is an example of a first value, and “0” is an example of a second value. The value of each bit is hereinafter referred to as a “bit value”. The control apparatus 1 sets all the bit values of the first bitmap 4 to “1” when starting copying of data. Then, when copying of data held in a block is completed, the control apparatus 1 changes the value of the bit corresponding to the block to “0”. When all the bit values of the first bitmap 4 are changed to “0”, copying is completed.

The control apparatus 1 is connected to a management apparatus 5. The management apparatus 5 transmits to the control apparatus 1 a request for creating a second bitmap 6 having a smaller number of bits than the first bitmap 4 (i.e., a request for converting the first bitmap 4 into a second bitmap 6 having a smaller number of bits than the first bitmap 4) by increasing the data size managed by each bit of the first bitmap 4. In this embodiment, the management apparatus 5 transmits to the control apparatus 1 a request for creating a second bitmap 6 having half the number of bits as the first bitmap 4 by doubling the data size managed by each bit of the first bitmap 4.

When the control apparatus 1 receives the request during copying of data from the first storage area 2a to the second storage area 3a, the identifying unit 1b detects a bit group 4a in which both the bit value “0” and the bit value “1” are present among bit groups of the first bitmap 4 that correspond to the respective bits of the second bitmap 6. Then, the identifying unit 1b identifies the bit 5 having the bit value “1” in the detected bit group 4a. More specifically, the identifying unit 1b determines whether different bit values are present in each group of two consecutive bits of the first bitmap 4 starting from the bit 0. Since the values of the bit 0 and the bit 1 are both “1”, the identifying unit 1b determines that different bit values will not be present even when these two bits are combined into a single bit. Since the values of the bit 2 and the bit 3 are both “0”, the identifying unit 1b determines that different bit values will not be present even when these two bits are combined into a single bit. Since the value of the bit 4 is “0” and the value of the bit 5 is “1”, the identifying unit 1b determines that different bit values will be present when these two bits are combined into a single bit. Accordingly, the identifying unit 1b identifies the bit 5 having the bit value “1” in the bit group 4a which contains the bits 4 and 5. Since the values of the bit 6 and the bit 7 are both “1”, the identifying unit 1b determines that different bit values will not be present even when these two bits are combined into a single bit.

The copy processing unit 1c copies data held in the block of the first storage area 2a that is managed by the bit 5 identified by the identifying unit 1b to the second storage area 3a. When copying of the data is completed, the bit value of the bit 5 is changed to “0”.

When the bit value of the bit 5 is changed to “0”, the setting unit 1d sets the bit value of the bit of the second bitmap 6 corresponding to the bit group 4a of the first bitmap 4 to “0”. More specifically, the setting unit 1d creates a second bitmap 6 having bits whose values are not fixed. Then, the setting unit 1d sets the bit value “1” of the bits 0 and 1 of the first bitmap 4 as the bit value of a bit 0 of the second bitmap 6. Then, the setting unit 1d sets the bit value “0” of the bits 2 and 3 of the first bitmap 4 as the bit value of a bit 1 of the second bitmap 6. Then, the setting unit 1d sets the bit value “0” of the bits 4 and 5 of the first bitmap 4 as the bit value of a bit 2 of the second bitmap 6. When the operation of setting a bit value to each bit of the second bitmap 6 is completed, the setting unit 1d releases the storage area of the bitmap storing unit 1a storing the first bitmap 4 so as to allow overwriting with other information.

The copy processing unit 1c copies data stored in a yet-to-be-copied area in the first storage area 2a to the second storage area 3a with use of the second bitmap 6. By creating the second bitmap 6 and replacing the first bitmap 4 with the second bitmap 6, the usage of the bitmap per a session in the bitmap storage unit 1a may be reduced.

As described above, the control apparatus 1 replaces the first bitmap 4 with the second bitmap 6 after changing the bit value of the bit 5 of the bit group 4a to “0”. This prevents the area that has already been copied from being copied again. Accordingly, the time taken for copying may be reduced compared to the case where both the bits of the bit group 4a are copied.

Also, the first bitmap 4 used by the copy processing unit 1c may be converted into the second bitmap 6 without stopping copying of data from the first storage area 2a to the second storage area 3a. Accordingly, the operation of tasks may be less affected compared to the cases where data copying is stopped and resumed after setting a new copy session. Also, it may be possible to prevent a copy process from being redundantly performed due to resetting of a copy session.

The disclosed control apparatus will be described in greater detail in the following second embodiment.

### (B) Second Embodiment

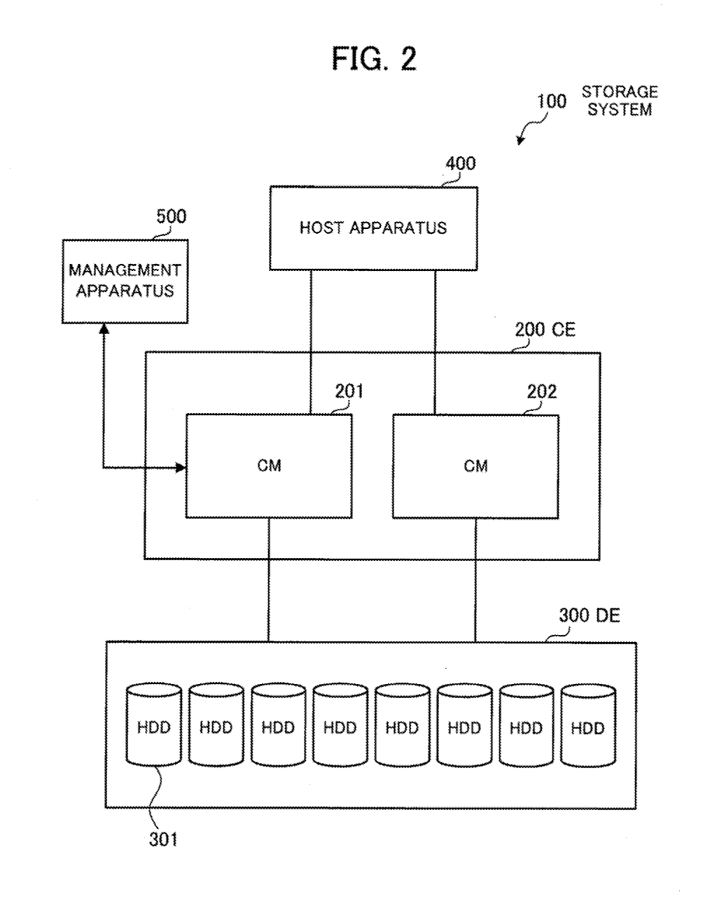

FIG. 2 illustrates an exemplary configuration of a storage system 100 according to a second embodiment. The storage system 100 illustrated in FIG. 2 includes a controller enclosure (CE) 200 and a drive enclosure (DE) 300. A host apparatus 400 is connected to the controller enclosure 200.

The controller enclosure 200 includes controller modules (CMs) 201 and 202. Each of the controller modules 201 and 202 is an example of the control apparatus, and is configured to read data from and write data to storage devices included in the drive enclosure 300 in response to an In/Out (I/O) request from the host apparatus 400. The controller modules 201 and 202 manage physical storage areas, which are implemented as the storage devices included in the drive enclosure 300, using Redundant Arrays of Inexpensive Disks (RAID), and control access to these physical storage areas.

It should be noted that the host apparatus 400 and the controller modules 201 and 202 may be connected to each other via a router or the like. Also, there may be only one controller module in the controller enclosure 200, or there may be three or more controller modules. The provision of a plurality of controller modules makes the system for controlling access to the drive enclosure 300 redundant, and thereby improves the reliability of the access control process.

The drive enclosure 300 includes a plurality of storage devices to be accessed by the controller modules 201 and 202. The drive enclosure 300 of this embodiment is a disk array apparatus including HDDs as storage devices. Examples of storage devices included in the drive enclosure 300 may include other types of non-volatile storage devices such as SSD. Further, a plurality of drive enclosures 300 may be connected to the controller enclosure 200.

The host apparatus 400 requests the controller modules 201 and 202 to access the HDDs in the drive enclosure 300 in response to an operation by the user. For example, the host apparatus 400 may read data from the HDDs in the drive enclosure 300 and write data to the HDDs in the drive enclosure 300 through any of the controller modules 201 and 202 in response to an operation by the user. Also, the host apparatus 400 may specify a copy area in an HDD in the drive enclosure 300 and instruct the controller enclosure 200 to copy data in the specified copy area to another HDD in the drive enclosure 300. In the following description, a unit of copy area specified by the host apparatus 400 is referred to as a “session”.

A management apparatus 500 manages operations of the storage system 100 in response to an operation by the administrator. For example, the administrator may configure operational settings for the controller modules 201 and 202 by operating the management apparatus 500. It should be noted that the management apparatus 500 is connected to the controller modules 201 and 202 via a Local Area Network (LAN) cable, for example. The host apparatus 400 may also serve as the management apparatus 500.

The controller modules 201 and 202 in the controller enclosure 200 have similar configurations and perform similar operations. Therefore, a description of only the controller module 201 will be given below, and a description of the controller module 202 will be omitted.

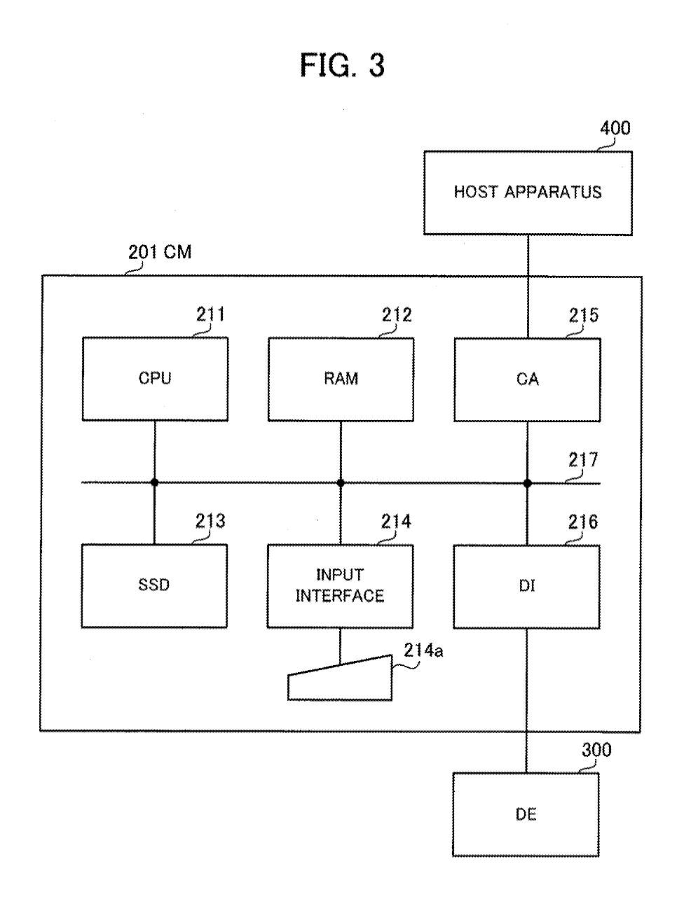

FIG. 3 illustrates an exemplary hardware configuration of the controller module 201.

The entire operation of the controller module 201 is controlled by a CPU 211. A RAM 212 and a plurality of peripheral devices are connected to the CPU 211 via a bus 217. The RAM 212 is used as a primary storage device of the controller module 201. The RAM 212 temporarily stores at least part of a program to be executed by the CPU 211, and various types of data used for processing performed by the program.

Examples of peripheral devices connected to the CPU 211 include an SSD 213, an input interface 214, a channel adapter (CA) 215, and a drive interface (DI) 216.

The SSD 213 is used as a secondary storage device of the controller module 201. The SSD 213 stores programs to be executed by the CPU 211, various types of data used for execution of the programs, and the like. It should be noted that other types of non-volatile storage devices such as HDD may be used as a secondary storage device, for example.

An input device 214a having operation keys and the like is connected to the input interface 214. The input interface 214 outputs a signal corresponding to an input operation performed on the input device 214a to the CPU 211.

The channel adapter 215 performs interface processing for exchanging data between the host apparatus 400 and the controller module 201. The channel adapter 215 and the host apparatus 400 communicate with each other in accordance with Fibre Channel (FC) standards, for example.

The drive interface 216 performs interface processing for exchanging data between the drive enclosure 300 and the controller module 201. The drive interface 216 and the drive enclosure 300 communicate with each other in accordance with Serial Attached SCSI (SAS) (SCSI: Small Computer System Interface) standards, for example.

Next, a description will be given of the hardware configuration of the management apparatus 500.

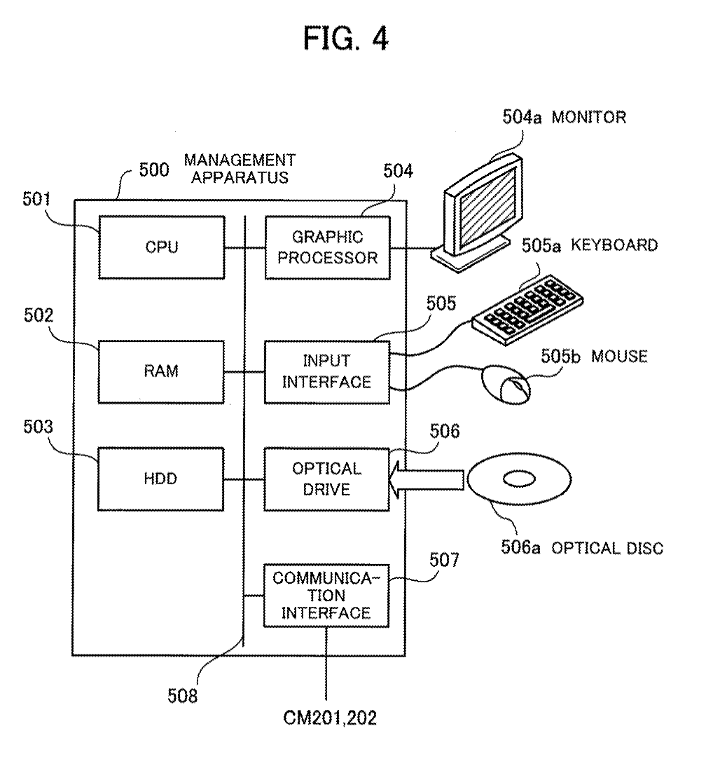

FIG. 4 illustrates an exemplary hardware configuration of the management apparatus 500.

The management apparatus 500 is implemented as a computer as illustrated in FIG. 4. The entire operation of this computer is controlled by a CPU 501. A RAM 502 and a plurality of peripheral devices are connected to the CPU 501 via a bus 508.

The RAM 502 is used as a primary storage device of the computer. The RAM 502 temporarily stores at least part of a program to be executed by the CPU 501. The RAM 502 also stores various types of data used for processing performed by the CPU 501.

The peripheral devices connected to the bus 508 include an HDD 503, a graphic processor 504, an input interface 505, an optical drive 506, and a communication interface 507.

The HDD 503 is used as a secondary storage device of the computer. The HDD 503 stores programs to be executed by the CPU 501 and various types of data. It should be noted that a semiconductor storage device such as a flash memory may be used as a secondary storage device.

A monitor 504a is connected to the graphic processor 504. The graphic processor 504 displays images on the screen of the monitor 504a in accordance with a command from the CPU 501. The monitor 504a may include a display device using a Cathode Ray Tube (CRT) and a liquid crystal display device.

A keyboard 505a and a mouse 505b are connected to the input interface 505, for example. The input interface 505 receives signals from the keyboard 505a and the mouse 505b, and transmits the received signals to the CPU 501. The mouse 505b is an example of a pointing device, and other types of pointing devices may also be used. Examples of other types of pointing devices include touch panels, tablets, touch pads, and track balls.

The optical drive 506 reads data from an optical disc 506a with use of laser beams. The optical disc 506a is a portable storage medium that stores data such that the data may be read utilizing optical reflection. The optical disc 506a may include digital versatile discs (DVD), DVD-RAM, compact disc read only memories (CD-ROM), CD-R (Recordable), and CD-RW (ReWritable).

The communication interface 507 exchanges data with the controller modules 201 and 202 via a LAN cable.

It should be noted that the host apparatus 400 may be implemented with the same configuration as that illustrated in FIG. 4. A communication interface of the host apparatus 400, however, exchanges data with the controller modules 201 and 202 through an optical fiber or the like.

The controller modules 201 and 202 having the configuration illustrated in FIG. 3 may have the following functions.

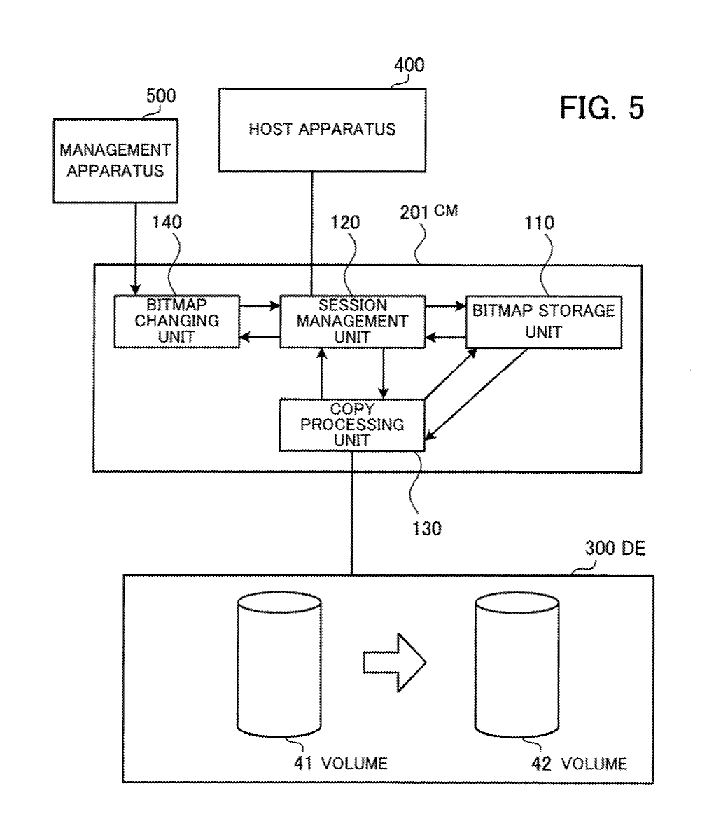

FIG. 5 is a functional block diagram of the controller module 201.

The drive enclosure 300 includes logical volumes 41 and 42, each of which is formed of part of the physical storage areas of a plurality of HDDs 301. The volumes 41 and 42 are formed of different physical storage areas among the physical storage areas implemented as the plurality of HDDs 301. In the following description, the volume 41 serves as the data copy source, while the volume 42 serves as the data copy destination.

The controller module 201 includes a bitmap storage unit 110, a session management unit 120, a copy processing unit 130, and a bitmap changing unit 140. The bitmap changing unit 140 is an example of an identifying unit and a setting unit.

The storage area of the volume 41 storing data to be copied to the volume 42 is divided into blocks. The bitmap storage unit 110 stores a bitmap that contains a single bit for each of the blocks. It should be noted that the bitmap is formed in a portion of the storage area of the RAM 212.

The session management unit 120 receives a copy command issued by the host apparatus 400 upon copying data from the volume 41 to the volume 42, and stores the contents of the received copy command in the session management table. Also, the session management unit 120 reports the contents of the copy command to the copy processing unit 130.

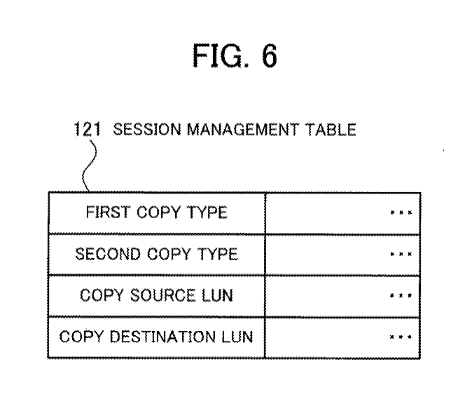

FIG. 6 illustrates an example of a session management table 121.

The session management table 121 stores a first copy type, a second copy type, a copy source logical unit number (LUN), and a copy destination LUN. The first copy type is information regarding a method of copying data. More specifically, the first copy type indicates information for identifying snapshot or mirroring.

Snapshot is a technique for instantaneously producing a copy of a data image at a particular point in time. The types of snapshot include a copy-on-write method and a background method. The copy-on-write method logically creates an instant copy of a disk image, and physically copies a data area to be updated when the data area is accessed. The background method produces a snapshot as an exact physical duplication of the original data. This method creates a copy of the entire data image in the background, in parallel with a copy-on-write operation.

Mirroring is a process that continuously transfers updates made in the volume 41 to the volume 42 such that the volume 41 and the volume 42 have the same contents, and stops transferring data from the volume 41 to the volume 42 (i.e., equivalent copy) in response to a separation command. Thus, a duplicate copy of the data stored in the volume 41 at the point of issue of the command into the volume 42 is created. Although copying of data within the drive enclosure 300 (casing) will be illustrated in this embodiment, data copying may be performed between the drive enclosure 300 and drive enclosures other than the drive enclosure 300.

The second copy type is information indicating the sub-types of the first copy type. For example, when the first copy type is “snapshot”, the second copy type indicates information for identifying the copy-on-write method or the background method.

The copy source LUN is information for identifying the volume 41.

The copy source LUN is information for identifying the volume 42.

When the copy processing unit 130 receives a request for a copy process from the session management unit 120, the copy processing unit 130 sets a copy session between the volume 41 and the volume 42 in accordance with a specified copy area of the volume 41. A copy session is a unit of management used for copying data from the volume 41 to the volume 42.

The copy processing unit 130 creates a volume management table for each of the volumes 41 and 42. The copy processing unit 130 updates the volume management tables when needed.

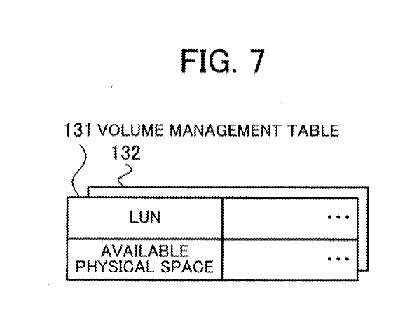

FIG. 7 illustrates examples of the volume management tables.

In a volume management table 131, the LUN of the volume 41 and the free space (available physical space) of the volume 41 are set. In a volume management table 132, the LUN of the volume 42 and the free space (available physical space) of the volume 42 are set.

In the following, a description will be given with reference again to FIG. 5.

The copy processing unit 130 also creates a bitmap that contains a single bit for each of the blocks of the copy area. The copy processing unit 130 stores the created bitmap in the bitmap storage unit 110. The copy processing unit 130 performs copying of data between the volume 41 and the volume 42 using the created bitmap and the copy session.

Upon performing data copying, the copy processing unit 130 sets a bit corresponding to a not-yet-copied area to “1” and sets a bit corresponding to an already-copied-area to “0” in the bitmap stored in the bitmap storage unit 110. Thus, the copy processing unit 130 manages the progress of copying of data from the volume 41 to the volume 42.

The bitmap changing unit 140 changes the data size managed by each bit of the bitmap stored in the bitmap storage unit 110 if an instruction (hereinafter referred to as a “change instruction”) for changing the data size managed by each bit of the bitmap is transmitted from the management apparatus 500 while the copy session is established.

The following will describe the method performed by the bitmap changing unit 140 to change the data size managed by each bit of the bitmap in accordance with the change instruction. More specifically, a method of reducing the data size managed by each bit and thereby creating a bitmap with an increased number of bits (hereinafter referred to as a “first changing method”) and a method of increasing the data size managed by each bit and thereby creating a bitmap with a reduced number of bits (hereinafter referred to as a “second changing method”) will be described in this order.

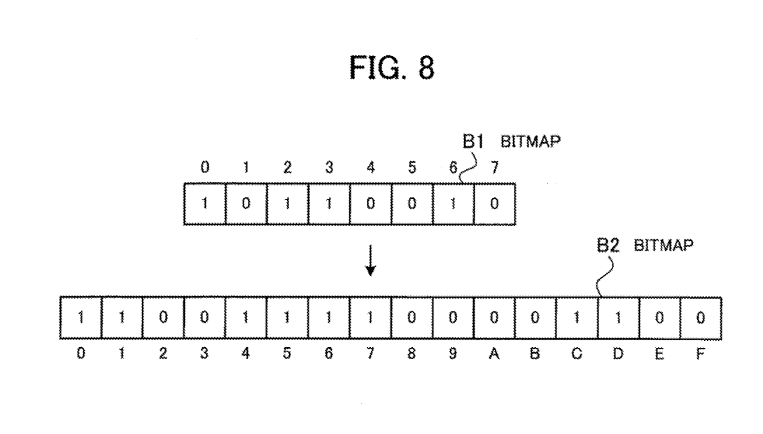

FIG. 8 illustrates the first changing method.

The first changing method extends each bit to a plurality of bits in accordance with a target data size. In FIG. 8, an example of the first changing method that reduces the data size managed by each bit of a bitmap B1 to half the original data size is illustrated.

The bitmap changing unit 140 causes the copy processing unit 130 to temporarily suspend a copy process regardless of the first copy type (snapshot, mirroring). Then, the bitmap changing unit 140 obtains a bitmap B1 from the bitmap storage unit 110. Then, the bitmap changing unit 140 extends the value of each bit of the obtained bitmap B1 to two values in the order from a bit 7, a bit 6, . . . , to a bit 0, in accordance with a target data size. Further, the extended bit values are stored in the corresponding bits of a bitmap B2.

For example, since the value of the bit 7 of the bitmap B1 is “0”, the bitmap changing unit 140 extends the value of the bit 7 to “00”. After that, the bitmap changing unit 140 stores the extended bit values “00” in bits E and F, respectively, of the bitmap B2. Then, since the value of the bit 6 of the bitmap B1 is “1”, the bitmap changing unit 140 extends the value of the bit 6 to “11”. After that, the bitmap changing unit 140 stores the extended bit values “11” in bits C and D, respectively, of the bitmap B2.

The bit 7, the bit 6, . . . , and the bit 0 of the bitmap B1 are processed in this order because if processing is started from the bit 0, the values of bits that have not yet been extended will be overwritten when information indicating extended bit values are stored.

The bitmap changing unit 140 causes the copy processing unit 130 to resume the suspended copy process when values are stored in bits 0 and 1 of the bitmap B2.

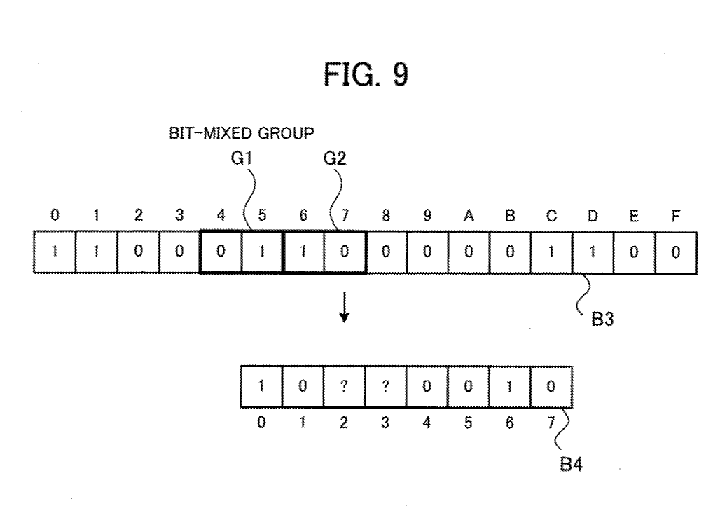

FIG. 9 illustrates the second changing method.

In FIG. 9, an example of the second changing method that doubles the data size managed by each bit of a bitmap B3 is illustrated.

The following describes the second changing method in the case where the first copy type is “snapshot” and in the case where the first copy type is “mirroring” in this order.

(i) In the Case where First Copy Type is “Snapshot”

The bitmap changing unit 140 doubles the data size managed by each bit of the bitmap B3. Thus, the bitmap changing unit 140 identifies the area where different bit values, i.e., “0” and “1”, will be present, and the area where different bit values will not be present in the bitmap B4.

In the case of doubling the data size managed by each bit of the bitmap B3, each two adjacent bits form a group of bits to be combined. In the following description, a bit group of the bitmap B3 in which the bit values “0” and “1” are present is referred to as a “bit-mixed group”.

In FIG. 9, bits 4 and 5 of the bitmap B3 have different values (i.e., “0” and “1”, respectively), and thus form a bit-mixed group G1. Also, bits 6 and 7 have different values (i.e., “1” and “0”, respectively), and thus form a bit-mixed group G2.

In this case, as for bits 2 and 3 of the bitmap B4 indicated by the question marks in FIG. 9, in both the case where the bit value is set to “0” and the case where the bit value is set to “1”, data that will be written in the volume 42 are likely to be corrupted.

For example, in the case where the values of the bits 2 and 3 of the bitmap B4 are set to “1” and then data in the storage of the volume 41 managed by the bits 2 and of the bitmap B4 are updated, if the updated storage area is specified as the area to be copied to the volume 42, a plurality of data pieces corresponding to the same area are likely to be written. Therefore, data that are different from the data at the time point of creation of a snapshot may be copied to the volume 42.

To avoid this problem, the bitmap changing unit 140 causes the copy processing unit 130 to copy data stored in the storage area corresponding to the bit 5 of the bitmap B3 and data stored in the storage area corresponding to the bit 6 of the bitmap B3 to the volume 42. After completion of copying by the copy processing unit 130, the bitmap changing unit 140 changes the value of each of the bits 5 and 6 of the bitmap B3 from “1” to “0”. When all the bit-mixed groups are eliminated, the bitmap changing unit 140 causes the copy processing unit 130 to temporarily suspend the copy process, and stores the value of each bit of the bitmap B3 in the corresponding bit of the bitmap B4. More specifically, the bitmap changing unit 140 stores the value of each bit of the bitmap B3 in the corresponding bit of the bitmap B4 in the order from the bit 0, the bit 1, . . . , to the bit F, in accordance with the multiplying factor for changing the data size. More specifically, “0” is stored when the values of two adjacent bits are “00”, and “1” is stored when the values of two adjacent bits are “11”. Since the values of the bit 0, the bit 1, . . . , and the bit F of the bitmap B3 are stored in this order, it is possible to prevent the values of bits that have not yet been processed from being overwritten. Upon completion of this processing, the bitmap changing unit 140 releases the bitmap B3 stored in the bitmap storage unit 110 and causes the copy processing unit 130 to resume the suspended copy process. The copy processing unit 130 performs the copy process using the bitmap B4.

If the second copy type is “copy-on-write”, the copy processing unit 130 starts backing up data when the host apparatus 400 issues a Write I/O. That is, if the second copy type is “copy-on-write”, the copy processing unit 130 does not perform a copy process for backing up data until issuance of a Write I/O. Therefore, when the bitmap changing unit 140 converts the bitmap B3 into the bitmap B4, a copy process is performed for a storage area having the bit value “1” in each bit-mixed group. Therefore, a physical space for storing the result of the copy process needs to be reserved in the volume 42.

Accordingly, the copy processing unit 130 calculates the number of copy operations to be performed for bits having the value “1” in respective bit-mixed groups on the basis of the number of bits having the value “1” in respective bit-mixed groups that are identified by the bitmap changing unit 140. Thus, the copy processing unit 130 calculates the physical space of the volume 42 to be used for storing the results of the copy processes.

If the physical space of the volume 42 is insufficient, the copy processing unit 130 dynamically allocates a storage area from the pool area to the volume 42 so as to overcome the shortage of storage area. If the shortage of storage area is not overcome, the copy processing unit 130 reports the shortage of storage area to the management apparatus 500.

The pool area is a portion of an unused physical storage area of the HDDs of the drive enclosure 300 that may be allocated to the volume 41 and the volume 42. The address indicating the location of the pool area is registered in a pool area management table (not illustrated).

(ii) In the Case where First Copy Type is “Mirroring”

When the value of each of the bits 2 and 3 of the bitmap B4 corresponding to the bit-mixed groups of the bitmap B3 is set to “1”, the copy processing unit 130 copies to the volume 42 again the data that are stored in the storage area of the volume 41 and have already been copied to the volume 42. In the case where the first copy type is “mirroring”, even if copying is performed again, since the same data are written to the volume 42 before the copying and after the copying, no data corruption occurs. However, a copy process is redundantly performed. In order to prevent a copy process from being redundantly performed, as in the case of snapshot, when a bit-mixed group is present, the bitmap changing unit 140 causes the copy processing unit 130 to perform a copy process. Then, when the bit-mixed group is eliminated, the bitmap changing unit 140 stores a bit value in each bit of the bitmap B4 in accordance with the multiplying factor for changing the data size. This eliminates a redundant copy process.

Next, a description will be given of operations of the controller module 201. In the following description, bitmaps such as the bitmaps B1 and B3 that have already been stored in the bitmap storage unit 110 at the time a change instruction is transmitted from the management apparatus 500 are referred to as “existing bitmaps”.

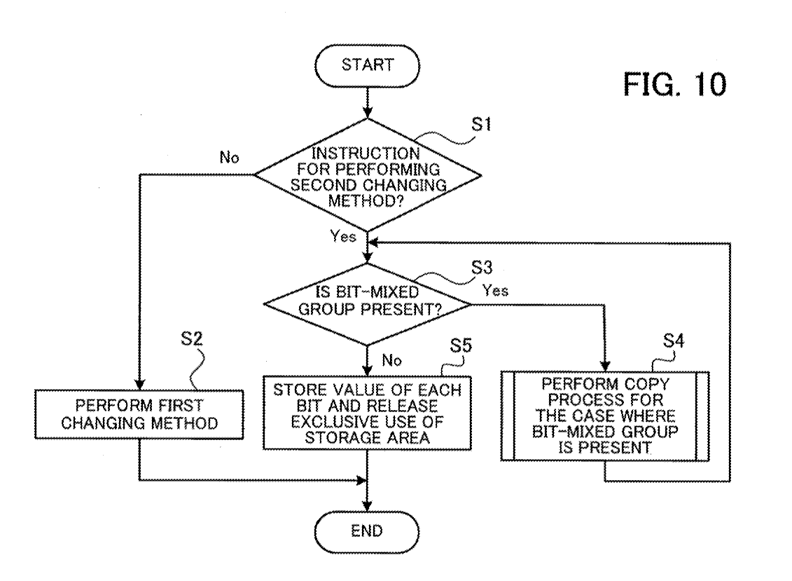

FIG. 10 is a flowchart of a process performed by the controller module 201.

(Step S1) When a change instruction is transmitted from the management apparatus 500 while a copy session is established between the volume 41 and the volume 42, the bitmap changing unit 140 determines whether the change instruction is an instruction for performing the second changing method. If the instruction is for performing the second changing method (Yes in Step S1), the process proceeds to Step S3. If the instruction is one for performing the first changing method (No in Step S1), the process proceeds to Step S2.

(Step S2) The bitmap changing unit 140 obtains a new storage area from the RAM 212. Then, the bitmap changing unit 140 performs the first changing method using the obtained storage area so as to reduce the data size managed by each bit and thereby increase the number of bits of the bitmap. Then, the process of FIG. 10 is ended.

(Step S3) The bitmap changing unit 140 determines whether a bit-mixed group is present in the existing bitmap. If a bit-mixed group is present in the existing bitmap (Yes in Step S3), the process proceeds to Step S4. If no bit-mixed group is present in the existing bitmap (No in Step S3), the process proceeds to Step S5.

(Step S4) The bitmap changing unit 140 performs a copy process for the case where a bit-mixed group is present. The copy process for the case where a bit-mixed group is present will be described in greater detail below. When the copy process for the case where a bit-mixed group is present is finished, the process proceeds to Step S3.

(Step S5) The bitmap changing unit 140 stores the value of each bit of the existing bitmap in the corresponding bit of a newly created bitmap. When the operation of storing the value of each bit is completed, the storage area of the RAM 212 that has been exclusively used for storing the existing bitmap is released. Then, the process of FIG. 10 is ended.

Next, a description will be given of a copy process in Step S4 that is performed in the case where a bit-mixed group is present.

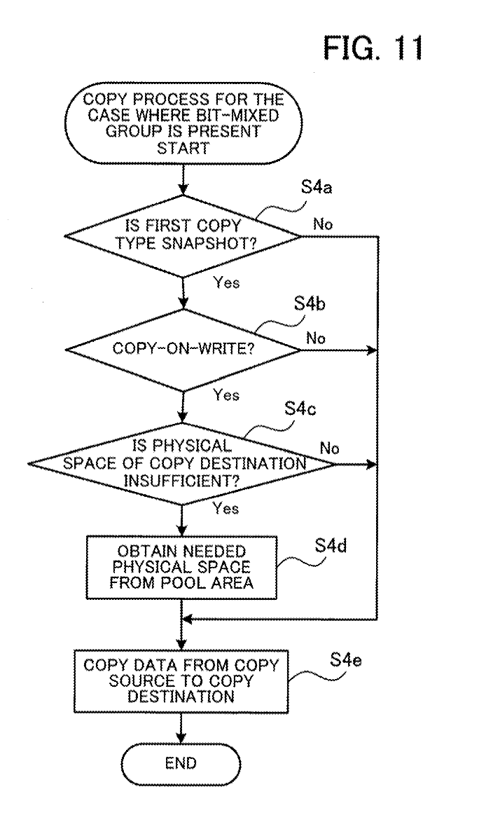

FIG. 11 is a flowchart of a copy process for the case where a bit-mixed group is present.

(Step S4a) The copy processing unit 130 refers to the first copy type stored in the session management table 121, and determines whether the first copy type is “snapshot”. If the first copy type is “snapshot” (Yes in Step S4a), the process proceeds to Step S4b. If the first copy type is not “snapshot” but is “mirroring” (No in Step S4a), the process proceeds to Step S4e.

(Step S4b) The copy processing unit 130 refers to the second copy type stored in the session management table 121, and determines whether the second copy type is “copy-on-write”. If the second copy type is “copy-on-write” (Yes in Step S4b), the process proceeds to Step S4c. If the second copy type is not “copy-on-write” (No in Step S4b), the process proceeds to Step S4e.

(Step S4c) The copy processing unit 130 determines whether the physical space of the volume 42 becomes insufficient due to conversion of the bitmap. More specifically, the copy processing unit 130 calculates the maximum possible increase in the use of the physical space on the basis of the multiplying factor specified in the change instruction. The following describes the case where the change instruction is one for increasing the data size managed by each bit to 16 times the original data size and thereby reducing the number of bits of the bitmap to 1/16 of the original number of bits.

When bit-mixed groups contain fifteen bits having the value “1” and one bit having the value “0”, data corresponding to the fifteen bits of the existing bitmap will be written to the volume 42. Accordingly, the copy processing unit 130 compares the maximum possible increase in the use of the physical space, i.e., the volume of data corresponding to the fifteen bits of the existing bitmap, with the available physical space. Then, if the volume of data corresponding to the fifteen bits exceeds the available physical space, the copy processing unit 130 determines that the physical space of the volume 42 is insufficient. In this way, in the case of increasing the data size managed by each bit to n (n>1) times the original data size, the copy processing unit 130 compares the volume of data corresponding to (n−1) bits, i.e., the maximum possible increase in the use of the physical space, with the available physical space. Then, if the volume of data corresponding to (n−1) bits exceeds the available physical space, the copy processing unit 130 determines that the physical space of the volume 42 is insufficient.

If the copy processing unit 130 determines that the physical space of the volume 42 is insufficient (Yes in Step S4c), the process proceeds to Step S4d. If the copy processing unit 130 determines that the physical space of the volume 42 is sufficient (No in Step S4c), the process proceeds to Step S4e.

(Step S4d) The copy processing unit 130 obtains the physical space needed to perform a copy process from the pool area in the drive enclosure 300, and additionally allocates the obtained physical space to the volume 42. Then, the process proceeds to Step S4e.

(Step S4e) The copy processing unit 130 copies data corresponding to the bit having the value “1” in the bit-mixed group of existing bitmap from the storage area of the volume 41 to the volume 42. Then, the process of FIG. 11 is ended.

Although an increase in the use of the physical space in the volume 42 is calculated upon conversion of the bitmap in the flowchart of FIG. 11, the controller module 201 may simulate the available physical space of the volume 42 to be reserved for conversion of the bitmap. More specifically, if an instruction (hereinafter referred to as a “simulation instruction”) for calculating the available physical space of the volume 42 to be reserved for changing the data size managed by each bit by applying a predetermined multiplying factor is transmitted from the management apparatus 500, the bitmap changing unit 140 performs a simulation process described below.

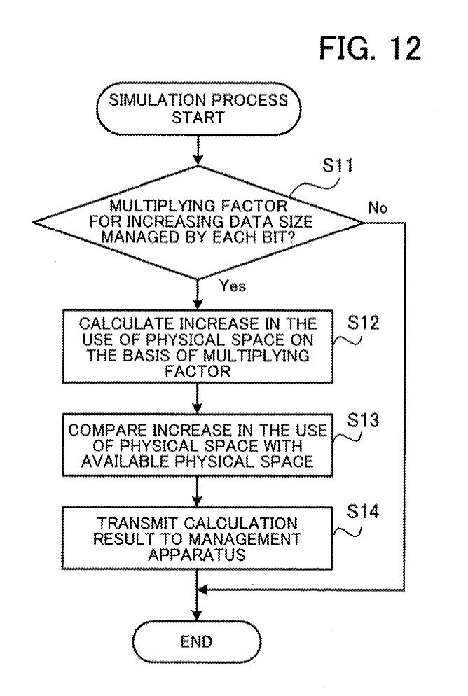

FIG. 12 is a flowchart of a simulation process.

(Step S11) The bitmap changing unit 140 determines whether the multiplying factor specified in the simulation instruction transmitted from the management apparatus 500 is for increasing the data size managed by each bit. If the multiplying factor is for increasing the data size managed by each bit (Yes in Step S11), the process proceeds to Step S12. If the multiplying factor is for reducing the data size managed by each bit or if the multiplying factor is 1 (No in Step S11), the process of FIG. 12 is ended.

(Step S12) The bitmap changing unit 140 calculates, for the existing bitmap stored in the bitmap storing unit 110, the maximum possible increase in the use of the physical space on the basis of the multiplying factor specified in the simulation instruction in the same manner described in Step S4c of FIG. 11. More specifically, when increasing the data size managed by each bit n times the original data size, the bitmap changing unit 140 calculates the volume of data corresponding to (n−1) bits, i.e., the maximum possible increase in the use of the physical space. Then, the process proceeds to Step S13.

(Step S13) The bitmap changing unit 140 compares the maximum possible increase in the use of the physical space calculated in Step S12 with the available physical space, determines whether the physical space of the volume becomes insufficient if the multiplying factor is actually applied, and if the physical space becomes insufficient, calculates how much space is insufficient. Then, the process proceeds to Step S14.

(Step S14) The bitmap changing unit 140 transmits the calculation result of Step S12 and the determination result of Step S13 to the management apparatus 500. Then, the process of FIG. 12 is ended.

As described above, the controller enclosure 200 allows the bitmap B3 to be converted into the bitmap B4 when a copy session is present between the volume 41 and the volume 42. This eliminates the need to reset a copy session upon conversion of the bitmap, and thus the operation of existing tasks may be less affected.

Also, it may be possible to prevent the same data items from being written to the same storage area due to resetting of the copy session. Therefore, the time taken to perform data copying may be reduced.

Further, in the case of performing an operation of remote copy (REC) to a remote storage apparatus, since a copy process is prevented from being redundantly performed, the volume of data transmitted through the line is reduced, which allows effective use of the line bandwidth.

Although the controller enclosure 200 converts the bitmap in response to an instruction from the management apparatus 500 in the above embodiment, the controller enclosure 200 may automatically determine the situation in which a bitmap conversion needs to be performed, and may automatically perform a bitmap conversion. In the case where the controller enclosure 200 automatically determines the situation in which a bitmap conversion needs to be performed, the reference volume of a bitmap to perform a bitmap conversion and the multiplying factor used for the bitmap conversion are set in advance in the controller enclosure 200. Then, if the volume of the bitmap exceeds the set reference volume due to an increased number of copy sessions or the like, the controller enclosure 200 automatically performs a bitmap conversion.

The control apparatus, the control method, and the storage apparatus according to the present disclosure have been described above with reference to the embodiments illustrated in the drawings. However, the present disclosure is not limited thereto, and the elements described in the above embodiments may be replaced with elements that have other configurations but have similar functions. Further, any other element or step may be added to the control apparatus, the control method, and the storage apparatus of the present disclosure.

Further, the control apparatus, the control method, and the storage apparatus of the present disclosure may be implemented as a combination of any two or more elements (features) described in the preceding sections.

The above-described processing functions may be implemented on a computer system. To achieve this implementation, the instructions describing the functions of the control apparatus 1 and the controller modules 201 and 202 are encoded and provided in the form of computer programs. A computer system executes those programs to provide the processing functions discussed in the preceding sections. The programs may be stored in a computer-readable recording medium. Such computer-readable recording media include magnetic storage devices, optical discs, magneto-optical storage media, semiconductor memory devices, and other tangible storage media. Magnetic storage devices include hard disk drives (HDD), flexible disks (FD), and magnetic tapes, for example. Optical disc media include DVD, DVD-RAM, CD-ROM, CD-RW, and others. Magneto-optical storage media include magneto-optical discs (MO), for example.

Portable storage media, such as DVD and CD-ROM, are used for distribution of program products. Network-based distribution of software programs may also be possible, in which case several master program files are made available on a server computer for downloading to other computers via a network.

A computer stores necessary software components in its local storage unit, which have previously been installed from a portable storage medium or downloaded from a server computer. The computer executes programs read out of the local storage unit, thereby performing the programmed functions. Where appropriate, the computer may execute program codes read out of a portable storage medium, without installing them in its local storage unit. Another alternative method is that the computer dynamically downloads programs from a server computer when they are demanded, and executes the programs upon delivery.

The processing functions discussed in the preceding sections may also be implemented wholly or partly by using a digital signal processor (DSP), application-specific integrated circuit (ASIC), programmable logic device (PLD), or other electronic circuit.

The area that has been already copied may be prevented from being copied again.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A control apparatus comprising:
a processor configured to perform a procedure including:
detecting, upon receiving a request for creating a second bitmap having a smaller number of bits than a first bitmap, which has a plurality of bits indicating progress of data copying, by increasing a data size managed by each of the bits of the first bitmap during copying of data from a first storage area to a second storage area, a bit group in which a first value indicating non-completion of data copying and a second value indicating completion of data copying are present among bit groups of the first bitmap that correspond to respective bits of the second bitmap, and identifying a bit having the first value in the detected bit group,
copying data managed by the identified bit to the second storage area, and changing the first value of the identified bit to the second value, and
creating the second bitmap, and setting to the second value a bit of the second bitmap that corresponds to the bit group containing the identified bit whose value has been changed from the first value to the second value.

2. The control apparatus according to claim 1,
wherein the copying the data managed by the identified bit to the second storage
determines whether a type of the data copying is copy-on-write and, when the type of the data copying is determined to be copy-on-write, calculates a physical space needed for copying the data managed by the identified bit to the second storage area so as to determine whether the calculated physical space is available in the second storage area, and
adds a physical space obtained from a storage pool to the second storage area when the calculated physical space is not available in the second storage area.

3. The control apparatus according to claim 1, wherein the creating the second bitmap reads values of bits of the first bitmap in the ascending order of bit numbers assigned to the bits of the first bitmap, and sets each bit of the second bitmap to the first value or the second value on the basis of the read bit values.

4. The control apparatus according to claim 1, wherein the procedure further includes copying the data from the first storage area to the second storage area using the created second bitmap.

5. A control method comprising:
detecting, by a processor, upon receiving a request for creating a second bitmap having a smaller number of bits than a first bitmap, which has a plurality of bits indicating progress of data copying, by increasing a data size managed by each of the bits of the first bitmap during copying of data from a first storage area to a second storage area, a bit group in which a first value indicating non-completion of data copying and a second value indicating completion of data copying are present among bit groups of the first bitmap that correspond to respective bits of the second bitmap, and identifying a bit having the first value in the detected bit group;
copying, by the processor, data managed by the identified bit to the second storage area, and changing the first value of the identified bit to the second value; and
creating, by the processor, the second bitmap, and setting to the second value a bit of the second bitmap that corresponds to the bit group containing the identified bit whose value has been changed from the first value to the second value.

6. A storage apparatus comprising:
at least one storage device including a first storage area and a second storage area; and
a processor configured to perform a procedure including:
detecting, upon receiving a request for creating a second bitmap having a smaller number of bits than a first bitmap, which has a plurality of bits indicating progress of data copying, by increasing a data size managed by each of the bits of the first bitmap during copying of data from the first storage area to the second storage area, a bit group in which a first value indicating non-completion of data copying and a second value indicating completion of data copying are present among bit groups of the first bitmap that correspond to respective bits of the second bitmap, and identifying a bit having the first value in the detected bit group,
copying data managed by the identified bit to the second storage area, and changing the first value of the identified bit to the second value, and
creating the second bitmap, and setting to the second value a bit of the second bitmap that corresponds to the bit group containing the identified bit whose value has been changed from the first value to the second value.
